(19) United States
(12) Patent Application Publication
(10) Pub. No.: US 2008/0054504 A1
(43) Pub. Date: Mar. 6, 2008

(54) APPARATUS FOR ADDING HUMIDITY TO GAS

(75) Inventor: Saburo Aonuma, Shinagawa-ku (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sataco Co., Ltd., Shinagawa-ku (JP)

(21) Appl. No.: 11/621,746

(22) Filed: Jan. 10, 2007

(30) Foreign Application Priority Data
Aug. 31, 2006 (JP) 2006-265924

(51) Int. Cl. B01D 47/00

(52) U.S. Cl. 261/107

(57) ABSTRACT

An apparatus for adding humidity to gas having the pressures and flow rates adjustment means for adjusting degree of humidity easily and precisely.

The hollow-fiber membrane 1 for the subject gas passing therethrough, the closed enclosure 4 for maintaining the water element containing liquid 5 in contact with the hollow-fiber membrane 1 while maintaining the water level at a specified level 11, the subject gas passing internal hollow-fiber membrane 1, and, pumps 10 (P1, P2) connected to the inlet 8 of hollow-fiber membrane and inlet of the closed enclosure 4, and valves (V1, V2) are connected to the pumps respectively.

This application is based on the priority document of Japanese Patent Application No.2006-265924 filed on Aug. 31, 2006, and claims the benefits of priority thereof. The entire contents of the priority document are incorporated herein referring to the priority document.

### BACKGROUND OF THE INVENTION

This invention relates to an apparatus for adding humidity to a subject gas for adding humidity.

There is an apparatus known for adding humidity to a subject gas such as air or nitrogen gas using a hollow-fiber membrane made from an ion-exchange membrane such as perfluoro system. There is a following publication for such apparatus disclosed as a prior art.

Japanese Patent Publication JP H08-276019 published on Oct. 22, 1996. This publication describes a gas supplying device for breathing equipped with a humidifier without generating noise by bubble exploding sound, not like a bubble type humidifier, and with no leak of oxygen gas caused by imperfect handling.

In this patent publication, there are descriptions such as “humidity can be added to an oxygen gas to a desired degree of related humidity (such as 95%˜100%)”, and “the degree of humidity can be adjusted to a degree between a related humidity between 60% through 100% (preferably approximately 95%˜100%)”.

However, actually, in the structure described in this publication for adjusting humidity, only the volume of water 24 to be supplied from the water supply tank 22 should be controlled because the hollow-fiber membrane 4 is installed in an airtight container 5. In this publication there is description specifying “because the container 5 is in an airtight condition, the same volume of water consumed for adding humidity is supplied from the water supply tank 22.” As a result, a constant volume of water is simply supplied to the container 5. Therefore, it is difficult to perform a fine-tuning at a degree of humidity to the subject gas for adding humidity.

The present invention is provided in view of the above disadvantage. It is the object of the present invention to provide an apparatus for adding humidity to gas having function capable of adjusting degree of humidity to the subject gas easily and precisely.

According to the apparatus for adding humidity to gas of the present invention, it is preferred to include a hollow-fiber membrane for a subject gas to pass therethrough, a closed enclosure for maintaining a water element containing liquid therein at a specified level wherein the hollow-fiber membrane is installed in contact with the water element containing liquid for the subject gas to pass through the hollow-fiber membrane, and pressures and flow rates adjustment means for adjusting pressures and flow rates of the subject gas to be supplied into the hollow membrane and the closed enclosure respectively.

According to the apparatus for adding humidity to gas of the present invention, it is preferred to further include each of the pressures and flow rates adjustment means has pumps connected to an inlet of the hollow-fiber membrane and the other pump connected to an inlet of the close enclosure respectively, and valves disposed between one of the pumps and the hollow-fiber membrane, and between the other pump and the closed enclosure.

According to the apparatus for adding humidity to gas of the present invention, it is preferred to further include an external sleeve for covering the hollow-fiber membrane, openings are formed on the upper external sleeve, and a pressure of the subject gas for adding humidity is adjusted to equal to or higher than an internal pressure in the closed enclosure.

According to the apparatus for adding humidity to gas of the present invention, it is preferred to further include the external sleeve has a flexible property.

According to the apparatus for adding humidity to gas of the present invention, it is preferred to further include the water element containing liquid is an electrolyzed water.

### SUMMARY OF THE INVENTION

According to the apparatus for adding humidity to gas of the present invention, the water element containing liquid can be maintained at a specified surface level in contact with the hollow-fiber membrane and the internal ambient in the closed enclosure. The pressures and flow rates adjustment means are provided for adjusting pressures and flow rates of the subject gas to be supplied into the hollow membrane and the closed enclosure separately. As a result, the degree of humidity to the subject gas for adding humidity can be adjusted easily and precisely.

It is the object of the present invention to provide an apparatus for adding humidity to a subject gas having the pressures and flow rates adjustment means for adjusting degree of humidity easily and precisely.

### BRIEF DESCRIPTION OF THE DRAWINGS

FIG. 1 is a sectional view showing an apparatus for adding humidity to gas according to the present invention.

### A PREFERRED EMBODIMENT OF THE INVENTION

The above and other objects, features and advantages of this invention and the manner of attaining them will become more apparent, and the invention itself will best be understood, from a study of the following description of a preferred embodiments illustrated in the attached drawings.

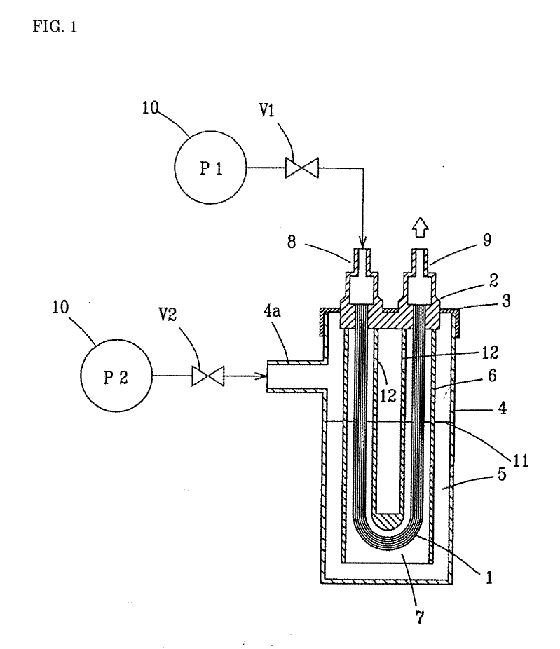

An embodiment of the present invention is described in details hereunder by referring to the drawing. FIG. 1 is a sectional view showing an apparatus for adding humidity to gas according to the present invention. According to the embodiment of the present invention, an apparatus for adding humidity to a subject gas includes a hollow-fiber membrane 1 and a closed enclosure 4 and the pressures and flow rates adjustment means are provided for adjusting pressures and flow rates of internal pressure in the closed enclosure 4, and adjusting pressures and flow rates of the subject gas into the hollow-fiber membrane 1. In particular, according to the embodiment of the present invention, the pressures and flow rates adjustment means are composed of pumps 10 (P1, P2) having an adjustable function for adjusting pressures, and valves (V1, V2) connected to each pumps for adjusting flow rates.

FIG. 1 is a sectional view showing an example of an apparatus for adding humidity to a subject gas according to the present invention. In FIG. 1, the apparatus for adding humidity to the subject gas having the hollow-fiber membrane 1 made from perfluoro system or an ion-exchange membrane etc. bent in U-character shape, a receptacle 2 made from an epoxy resin connected to the both ends of the hollow-fiber membrane 1, a cap member 3 made from an epoxy resin attached the receptacle thereon, a closed enclosure 4 made from an epoxy resin maintaining a water element containing liquid therein at a desired level, an electrolyzed water 5 as a water element containing liquid maintained in contact with the hollow-fiber membrane, an external sleeve 6 covering the hollow-fiber membrane 1 having openings 12 at upper portion thereof, the inlet 8 of the receptacle 2 for supplying a compressed gas to the hollow-fiber membrane from the pump 10 (P1) via the valve (V1), and the closed enclosure 4 having the inlet 4a for supplying a compressed gas from the pump 10 (P2) via the valve (V2).

The pumps 10 (P1, P2) can be provided separately or the pumps can be a single unit, however, a plurality of valves (V1, V2) may be provided to each path connecting with the single pump respectively.

Thus, pressures from the pumps 10 (P1, P2) are adjusted to specified pressures by adjusting their outputs, and flow rates are adjusted to specified flow rates using the valves (V1, V2).

The closed enclosure 4 may have an inlet for supplying the electrolyzed water 5 not shown in the figure so that the electrolyzed water 5 can be added to a specified level when the level becomes low. Also, an outlet not shown in the figure for draining the electrolyzed water 5 may be provided for maintenance period. Also, a level sensor not shown may be provided for detecting the level of the electrolyzed water 5. In addition, electromagnetic valves not shown may be provided for adjusting supply or draining.

The hollow-fiber membrane 4 is, for example, a plurality of ion-exchange polymer in thread shape are bound to constitute a membrane film. The receptacle 2 has the inlet port 8 and the outlet port 9, and both of the ports are connected with both ends of the hollow-fiber membrane 4.

The closed enclosure 4 maintains the electrolyzed water 5 and an internal gas (for example air) enclosed above the surface level of the electrolyzed water 5. Also, a connecting port 4a is provided on upper sidewall of the closed enclosure 4 for connecting with the pump 10 (P2) via the valve (V2).

At the bottom of the external sleeve 6, an opening 7 is provided; the electrolyzed water 5 enters therefrom inside the external sleeve 6 whereby the electrolyzed water 5 is provided in contact with the hollow-fiber membrane 1.

The pumps 10 (P1, P2) are gas compressors having a pressure adjustable function for adjusting the pressure of inside the closed enclosure 4 and the pressure of the subject gas into the hollow-fiber membrane respectively. The pumps 10 (P1, P2) may be any type of compressors including gas compressing piston pump, diaphragm pump, or rotary pump etc.

Next, operation of the apparatus for adding humidity to a subject gas of the present invention is described. First, the subject gas, for example, air or nitrogen for adding humidity is supplied from the inlet port 8 formed on the receptacle 2. The subject gas runs through the hollow-fiber membrane 1.

The subject gas is sufficiently added humidity while it goes through the hollow-fiber membrane, which is in contact with the electrolyzed water 5. The humidity added gas goes out from the outlet port 9 formed on the receptacle 2.

At this period, when the pressures from the pumps 10 (P1, P2) are increased by activating the pumps, the electrolyzed water 5 is expedited to penetrate the hollow-fiber membrane 1 easier. As a result, amount of water element from the electrolyzed water 5 increases for adding to the subject gas while it is passing through the hollow-finer membrane.

On the other hand, when the pressure of internal gas in the closed enclosure is decreased by activating the pumps 10 (P1, P2), the electrolyzed water 5 is depressed so that it is retarded to penetrate the hollow-fiber membrane 1. As a result, amount of water element from the electrolyzed water 5 reduces for adding to the subject gas passing through the hollow-finer membrane.

During such period, the pressure of the pump 10 (P1) connected to the inlet 8 is determined equal to or larger than the pressure of the pump 10 (P2). By this setting, the subject gas in upper part of the hollow-fiber membrane 1 above the surface level 11 exposed to the internal pressure in the closed enclosure 4 is prevented from going out from the pressure of the pump 10 (P1) to the pressure of the pump 10 (P2).

According to the apparatus for adding humidity to the subject gas of the present invention, in order to obtain a specified humidity of the subject gas from the outlet 9 formed on the receptacle 2, pressure and a flow rate of the pump 10 (P1), and pressure and a flow rate of the pump 10 (2) can be adjusted respectively.

In addition, the surface level 11 of the electrolyzed water 5 can be adjustably supplied to a specified surface level for obtaining a specified degree of humidity. By this adjustment, if the surface level is adjusted to a high level, surface area of the hollow-fiber membrane 1 in contact with the electrolyzed water 5 becomes large to make a degree of humidity high, if the surface level is adjusted to a low level, surface area of the hollow-fiber membrane 1 in contact with the electrolyzed water 5 becomes small to make a degree of humidity low.

By selecting the combination of the above adjustable factors, according to the apparatus for adding humidity to a subject gas of the present invention, the apparatus provides a hollow-fiber membrane 1 for the subject gas passing therethrough, a closed enclosure 4 for maintaining a water element containing liquid 5 therein at a specified level 11, and the subject gas for passing through the hollow-fiber membrane 1, and pressures and flow rates adjustment means for adjusting pressures and flow rates of the subject gas to be supplied into the hollow membrane and the closed enclosure respectively.

By this structure, the internal pressure and a flow rate of the subject gas in the closed enclosure 4, and pressure and a flow rate of the subject gas passing through the hollow-fiber membrane can be adjusted, and in addition, by adjusting the surface level of 11 of the electrolyzed water 5, an amount of a water element out of the electrolyzed water 5 or a water element containing liquid for adding to the subject gas can be precisely adjusted. By this structure, an apparatus having the features of adjusting a degree of humidity easily and precisely for adding humidity at a specified degree to the subject gas can be obtained.

According to the apparatus for adding humidity to gas of the present invention, each of the pressures and flow rates adjustment means including the pumps 10 (P1, P2) having the pressure adjustable function connected to an inlet 8 of the hollow-fiber membrane and the inlet 4a of the closed enclosure 4 respectively, and valves (V1, V2) disposed between one of the pumps 10 (P1) and the hollow-fiber membrane 1, and between one of the pumps 10 (P2) and the closed enclosure 4. Internal pressures can be easily adjusted to specified pressures by adjusting the pumps 10 (P1, P2) respectively, and flow rates can be adjusted to specified rates by adjusting the valves (V1, V2) respectively.

According to the embodiment of the present invention, the electrolyzed water 5 is used, for example, as a water element containing liquid. The electrolyzed water 5 has a bactericidal property, thereby providing a clean addition of humidity.

According to the embodiment of the present invention, the hollow-fiber membrane 1 is bent at the center thereof to form a U-character shape, however the shape of the hollow-fiber membrane cane be in a form of straight shape. In this case, the external sleeve 6 and the closed enclosure 4 can be also in the form of straight shape without losing the advantage of the present invention.

While the present invention is described in terms of preferred embodiments, however the above embodiments describe examples of the invention, and therefore many modifications, and variations are possible in light of the above teachings and within the scope of the appended claims without departing from the spirit and intended scope of the invention.

What is claimed is:

1. An apparatus for adding humidity to gas comprising:
a hollow-fiber membrane for subject gas passing therethrough,
a closed enclosure for maintaining a water element containing liquid therein at a specified level wherein said hollow-fiber membrane is installed in contact with said water element containing liquid,
said subject gas for passing through said hollow-fiber membrane, and pressures and flow rates adjustment means for adjusting pressures and flow rates of said subject gas to be supplied into said hollow membrane and said closed enclosure respectively.

2. An apparatus for adding humidity to gas of claim 1, wherein each of said pressures and flow rate adjustment means further comprising:
pumps connected to an inlet of said hollow-fiber membrane and said close enclosure respectively, and valves disposed between one of said pumps and said hollow-fiber membrane, and between one of said pumps and said closed enclosure.

3. An apparatus for adding humidity to gas of any one of claim 1 or 2, further comprising:
an external sleeve for covering said hollow-fiber membrane, openings are formed on said external sleeve, and a pressure of said subject gas for adding humidity is adjusted to equal to or higher than an internal pressure in said closed enclosure.

4. An apparatus for adding humidity to gas of any one of claim 1 through 3 wherein, said external sleeve has a flexible property.

5. An apparatus for adding humidity to gas of any one of claim 1 through 4 wherein, said water element containing liquid is an electrolyzed water.
